(19) United States
(12) Patent Application Publication
(10) Pub. No.: US 2012/0163748 A1
(43) Pub. Date: Jun. 28, 2012

(54) CAGE FOR A ROLLING BEARING AND ROLLING BEARING

(75) Inventors: Wolfram Henneberger, Memmelsdorf (DE); Bernhard Wilm, Nuedlingen (DE)

(73) Assignee: SCHAEFFLER TECHNOLOGIES AG & CO. KG, Herzogenaurach (DE)

(21) Appl. No.: 13/393,968

(22) PCT Filed: Aug. 20, 2010
(86) PCT No.: PCT/EP2010/062143

§ 371 Date: Mar. 2, 2012

(30) Foreign Application Priority Data
Sep. 3, 2009 (DE) 10 2009 040 008.7

(51) Int. Cl. F16C 33/46; F16C 33/58

(52) U.S. Cl. 384/564; 384/572; 384/576

(57) ABSTRACT

A cage for a rolling bearing, which has a first cage side ring, and a plurality of bars that protrude from the first cage side ring and are disposed at a distance from each other so as to form pockets to receive rolling elements. The first cage side ring has an elastically deformable segment in the region of each pocket. The segment is formed as a multiple bridge disposed between two adjacent bars. Also, a rolling bearing which includes the cage is further disclosed.

### FIELD OF THE INVENTION

The invention relates to a cage for a rolling bearing. The invention relates, furthermore, to a rolling bearing having such a cage.

Cages for rolling bearings are generally known. In this type of rolling bearing, they form an integral part of conventional rolling bearings, along with bearing rings, in particular an inner ring and an outer ring in the case of radially carrying rolling bearings, and along with a plurality of rolling bodies which are arranged between the two bearing rings.

Rolling bearings of this type serve, depending on their form of construction, for the transmission of radial and/or axial forces from a bearing inner ring, which, for example, may be arranged on a shaft rotating with respect to a housing, to an outer ring, which in this case is arranged in the housing and is fixed there. The rolling bodies are designed, for example, in the form of cylindrical rollers, barrel rollers or tapered rollers.

Where a roller bearing is concerned, the bearing rings may have one or even two guide rims in order to ensure axial guidance of the rolling bodies. The rolling bodies then run against the rims during operation when the shaft is subjected to axial load and/or when the bearing arrangement is adjusted, with the result that sliding contact occurs on the rim inner face.

In a rolling bearing, in this case the cage serves the purpose of guiding the rolling bodies when the rolling bearing is in operation, in that, for example, a uniform spacing of the rolling bodies from one another along the bearing circumference is ensured and, if possible, mutual contact between the individual rolling bodies is also prevented. When the mounting is in operation, cages for rolling bearings experience movement in the circumferential direction of the bearing and can be guided in the rolling bearing by the bearing inner ring, the bearing outer ring and/or the rolling bodies themselves.

The cage for a rolling bearing may be designed, for example, with pockets for receiving rolling bodies. These pockets may be formed by webs of suitable cross section which extend between two coaxially arranged cage side rings and which come to lie in each case between two rolling bodies after the rolling bearing has been assembled. A cage of this type for a tapered roller bearing is described in U.S. Pat. No. 3,477,773 A. Usually, in the assembled rolling bearing, the rolling bodies are arranged with greater or lesser play with respect to the pockets in which they are received.

Rolling bearings exist in the most diverse possible embodiments, depending on their application. Tapered roller bearings are especially suitable for combined axial and radial loads. As a rule, they are installed in pairs, the two tapered roller bearings being adjusted with respect to one another. The problem on which the present invention is based will be explained briefly below by the example of a tapered roller bearing, although the invention is not to be restricted to this.

Depending on the requirements placed upon the mounting, such as, for example, the accuracy of guidance of a mounted shaft or the resistance to vibrations in the case of a low bearing rotational speed, greater or lesser bearing clearance or else prestressing of the mounting, that is to say of two tapered roller bearings with respect to one another, must be ensured during fitting.

Particularly in the case of tapered roller bearings in which the running surface tapers in the axial direction, it may happen that, at the start of a fitting operation, the rolling bodies do not or do not all come to bear against a guide rim of a bearing ring in a desired operating position. If an adjusted mounting with a tapered roller bearing of this type is to be fitted and set, the mounting therefore has to be put into operation for a few revolutions. This takes place preferably in both directions of rotation until the rolling bodies bear against the guide rim of the bearing ring. Only then is it possible to have a correct setting of the axial play and therefore also of the radial play or the setting of the required prestress. Fitting is therefore difficult to carry out and is time-consuming.

If the bearing clearance or the prestress of the mounting is set, without the bearing being put into operation, there is the risk of an incorrect setting of the mounting, since in that case sometimes not all the rollers bear against the guide rim of the bearing ring.

Furthermore, while a tapered roller bearing is operating under load, in a similar way to when other rolling bearing types are in operation, the rolling bodies are usually exposed along the bearing circumference to a load which is variable in the circumferential direction. Thus, a loaded zone may be present in one portion of the bearing circumference and a relieved zone may be present in a further portion of the bearing circumference. The rolling body rotational speeds consequently likewise vary along the bearing circumference. This may lead to undesirable cyclically occurring deceleration and acceleration processes.

Also, the rolling bodies designed as tapered rollers may move away from the bearing ring rim, for example the inner ring rim, as a result of the transition from a loaded zone to a relieved zone. When a tapered roller enters the loaded zone again from the relieved zone, the tapered roller slides on the inclined running surface again in the direction of the bearing ring rim until it bears against this once more.

In order to avoid this undesirable sliding action, which is repeated with each revolution of the one bearing ring with respect to the other bearing ring, and in order to eliminate the abovementioned difficulties during fitting, it is advantageous if the tapered rollers come to lie under slight prestress against the rim of the bearing ring.

The Applicant has already proposed, in DE 43 38 350 A1, to simplify and speed up the fitting and setting of the rolling bearing, a bearing cage for a tapered roller bearing which is provided with a cage side margin designed to be elastically deformable. In order to avoid a spatially concentrated introduction of a large amount of heat into the rolling body cage manufactured from plastic in the region of a small elastic cage side ring of wavy shape, projections are provided on an opposite large diameter of the cage and engage behind a rim on the large diameter of the inner ring of the tapered roller bearing. These projections serve for supporting the cage against the rim during the prestressing of the rollers.

The object of the present invention is to provide a rolling bearing having improved running properties and possessing a cage.

This object is achieved by means of a cage according to the invention for a rolling bearing, as claimed in patent claim 1, and by means of a rolling bearing according to the invention, as claimed in patent claim 14.

Accordingly, there are provided:
a cage for a rolling bearing, with a first cage side ring and with a plurality of webs which are arranged in each case so as to project from the first cage side ring and are spaced apart from one another in such a way that pockets for receiving rolling bodies are thereby formed, the first cage side ring having in each case in the region of a pocket an elastically deformable portion which is designed as a multiple bridge arranged between two adjacent webs.
a rolling bearing, in particular a tapered roller bearing, having at least one cage according to the invention.

The idea of the present invention is to design a cage side ring in the region of its pockets, which are provided for receiving rolling bodies of a rolling bearing, in the form of multiple bridges. High elasticity of the side margin of the respective pocket is thereby achieved. In particular, what is achieved by this multiple bridge construction is that a rolling body which is received in the pocket and bears against the first cage side ring causes elastic deformation of the multiple bridge structure of the side margin of the pocket when axial force is applied to the rolling body. A prestressing force can thereby be exerted on the rolling body by means of the elastic spring action of the side margin.

Advantageous refinements and developments of the invention may be gathered from the further subclaims and from the description in conjunction with the figures of the drawing.

According to one development, the multiple bridge is designed symmetrically with respect to the radially extending mid-plane of the pocket. What is achieved thereby is that the elastic deformation of the multiple bridge likewise takes place symmetrically. Furthermore, what can thus be achieved is that neither of the two possible running directions of a rolling bearing is preferred in terms of the mechanical load-bearing capacity of the cage and in terms of its prestressing action with respect to the other running direction.

According to a further preferred development of the cage according to the invention, the multiple bridge is formed by at least two arcuate elastically designed subsections of the first cage side ring. Such a configuration makes it possible to carry out a directed setting of the desired elastic spring action.

According to a further especially preferred development of the cage according to the invention, the subsections are arranged in such a way that a respective curvature points away from an inner region of the pocket, said inner region being delimited by two adjacent webs and the first cage side ring. What is achieved by this arrangement is that the arcuate subsections are subjected to a bending load. A desired high elasticity of the elastically deformable portion is consequently achieved.

Preferably also, the multiple bridge is designed as a double bridge which is formed by two arcuate elastically designed subsections which are connected to one another in a connection region. A wall thickness of the two arcuate elastically designed subsections preferably first decreases from the connection region toward the webs on both sides, and then increases again. Thus, a middle region of each of the two arcuate elastically designed subsections of the first cage side ring acquires a thinner and more easily elastically deformable wall. The elastic spring action of the double bridge is improved further in this way.

According to a further highly advantageous embodiment of the cage according to the invention, a web is provided in the region of a radially inner and/or of a radially outer boundary surface in each case with a recess running in the longitudinal direction of the web. By recesses being provided in the webs projecting from the first cage side ring, particularly in the case of a cage cast in one piece, the cross-sectional ratios of portions adjacent to one another can be optimized and, above all, material accumulations which are located in the region of the webs and which could sometimes prove a disadvantage for the manufacturing operation are also avoided. Furthermore, an additional material saving is possible as a result of the recesses, precisely in the case of cages manufactured as injection moldings, with the result that such cages can additionally be produced more cost-effectively.

In a further development, this recess is designed in the form of a longitudinal groove provided in a web. A groove bottom of the longitudinal groove is advantageously provided with a rounding. Alternatively, the longitudinal groove may have a cross-section in the form of a segment of a circle, thus likewise giving rise to a rounded groove bottom. The configuration as a longitudinal groove is advantageous since the resistance of the web with respect to bending stress is thus in a very large part maintained, as compared with a web having a solid cross-section. Moreover, due to the rounded configuration of the longitudinal grooves, an undesirable concentration of mechanical stresses in the region of the groove bottom is avoided. It would, of course, also be conceivable to have a different cross-sectional shape of the groove, such as, for example, a rectangular or trapezoidal profile with rounded corners or a parabolic profile.

According to a further development, the recess running in the longitudinal direction of the web forms two ribs running in the longitudinal direction of the web and shaped symmetrically with respect to the recess. Each of the ribs is in this case connected to an end portion of an adjacent multiple bridge. A stable configuration of the end portions of the multiple bridge and favorable transmission of force from the first cage side ring to the web are thereby achieved.

In an advantageous refinement, a second cage side ring is provided. The second cage side ring is spaced apart from the first cage side ring and is connected to the first cage side ring via the webs. As a result, the mechanical load-bearing capacity of the cage is further improved and undesirable deformations in the case of use in a rolling bearing can be avoided.

In a further preferred refinement, the first cage side ring has a smaller diameter than the second cage side ring. Cages configured in this way are preferably used in tapered roller bearings, since the running surfaces for the rolling bodies constitute tapered surfaces.

According to a further development, the second cage side ring has a plurality of radially extending projections. These projections are designed in such a way that they can be inserted into an assigned groove provided on a bearing ring rim of a rolling bearing. When a prestressing force is exerted on the rolling body via the elastically deformable portion, designed as a multiple bridge, of the first cage side ring between two webs as a result of elastic deformation when a rolling body comes to bear, the cage can be supported on the bearing ring rim of the rolling bearing by means of the projections provided on the second cage side ring. Since the projections are formed on the second cage side ring and the multiple bridge, against the inside of which a rolling body comes to bear, at least in regions, and is in sliding contact with it, is provided on the first cage side ring, the frictional heat introduced can be distributed over a larger region of the cage and therefore a concentration of the heat introduced on a small area can be avoided. The above-described arrangement of the projections can prevent a situation where the cage is heated sharply in regions, especially when the cage is composed of a plastic material.

In a further advantageous embodiment, each of the pockets is assigned a projection. The projection assigned in each case to a pocket is designed symmetrically with respect to the radially extending mid-plane of the pocket. This contributes to a more uniform support of the prestressing force on the bearing ring rim and to a more uniform introduction of force into the second cage side ring.

Preferably also, the cage is manufactured in one piece from a thermoplastic, preferably from a polyimide. The processing method preferably used for the cage is injection molding.

In a preferred development of the rolling bearing provided according to the invention, one of the bearing rings has a bearing ring rim. A guide groove running in the circumferential direction of the bearing is provided on the bearing ring rim. The radially extending projections of a second cage side ring of the cage according to the invention surround the bearing ring rim in such a way that the projections engage into the guide groove.

The invention is explained in more detail below by means of the exemplary embodiments indicated in the diagrammatic figures in which:

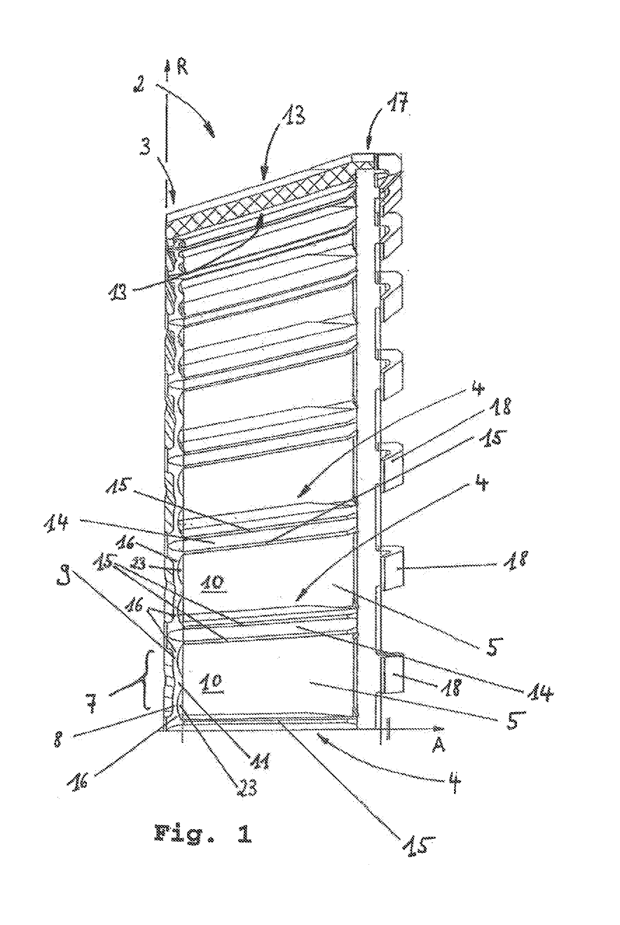

FIG. 1 shows an illustration of an upper half of the cage according to the invention for a tapered roller bearing in a section drawn through the cage axis A;

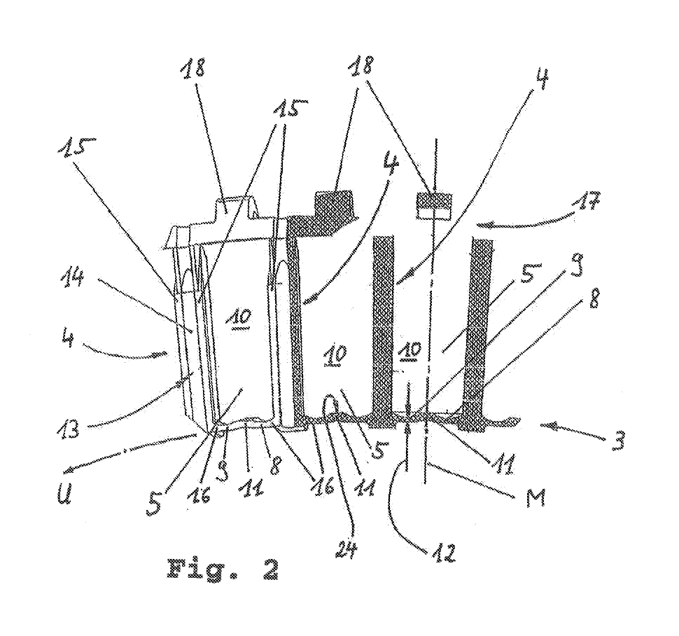

FIG. 2 shows an illustration of three pockets of the cage according to the invention, as shown in FIG. 1, illustrated in a section drawn tangentially;

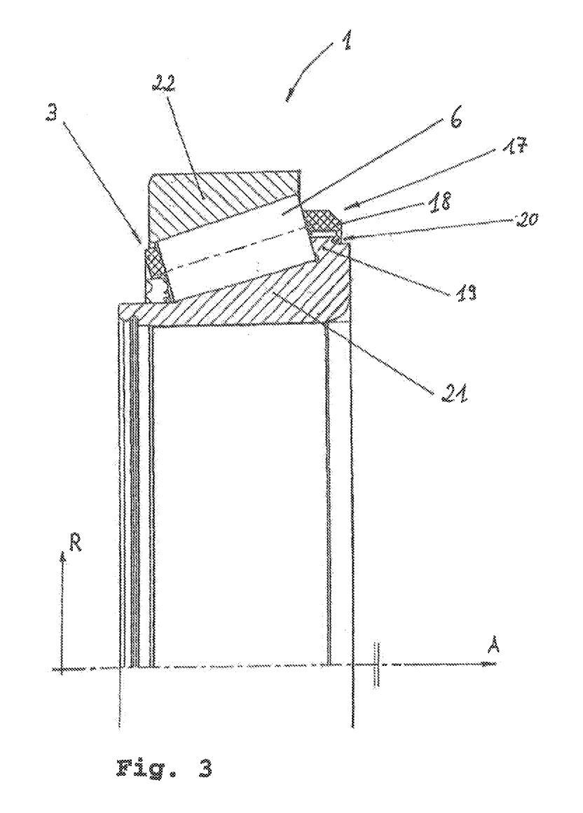

FIG. 3 shows a sectional illustration of a tapered roller bearing with a cage according to the invention in the assembled state.

Identical and functionally identical elements and features are given the same reference symbols in the figures of the drawing, unless specified otherwise.

FIG. 1 shows a sectional illustration of an upper half of a cage 2 according to the invention for a tapered roller bearing, not illustrated here. The lower half of the cage 2 is not illustrated here, since it is designed symmetrically to a cage axis A. The cage axis A corresponds to an axial direction of the tapered roller bearing 1 to which the cage 2 is assigned. In the same way, the radial direction R corresponds with respect to the cage 2 to the radial direction of the tapered roller bearing 1. In FIG. 1, the sectional plane is drawn through the cage axis A.

Two spaced-apart cage side rings 3, 17 are arranged coaxially in two parallel planes which extend perpendicularly with respect to the cage axis A. The cage side rings 3, 17, in particular a first cage side ring 3 and a second cage side ring 17, in each case possess essentially the shape of a circular ring. The cage 2 illustrated in FIG. 1 has a first cage side ring 3, the diameter of which is smaller here than the diameter of the second cage side ring 17. As a result of this configuration, the cage can be arranged between an inner ring 21 and an outer ring 22 of a tapered roller bearing 1 which both have tapered running surfaces.

A plurality of webs 4 are arranged between the two cage side rings 3, 17. The webs 4 project from the two cage side rings 3, 17 and are connected to the two cage side rings 3, 17 in such a way that the webs 4 and the cage side rings 3, 17 form a component manufactured in one piece. Each of the webs 4 has a boundary surface 13 lying internally in the radial direction R and one lying externally in the radial direction R.

In the interspaces between the webs 4, pockets 5 are formed, which are delimited on both sides in the axial direction A by the two cage side rings 3, 17. Each of the pockets 5 is provided for receiving a tapered roller 6 and for this purpose has a suitably shaped and dimensioned inner region 10. Since pockets 5 are provided, the cage 2 can ensure that, during operation, tapered rollers 6 of a tapered roller bearing 1 do not touch one another and, spaced apart uniformly over the bearing circumference, unroll on the bearing rings 21, 22.

The first cage side ring 3 delimits the inner region 10 of each pocket 5 on the left side and thus forms a left side margin of the pocket 5. The first cage side ring 3 has an elastically deformable portion 7 in each case in the region of a pocket 5. The elastically deformable portion 7 constitutes part of the first cage side ring 3 and possesses the shape of a double bridge which spans the distance between two adjacent webs 4.

A mid-plane M, extending in the radial direction R, of the pocket 5 can be defined in the middle of the distance between two webs 4 along the circumference of the cage 2.

FIG. 2 shows an illustration of a portion, composed of three pockets 5, of the cage 2 according to the invention in the exemplary embodiment of FIG. 1. In this case, the mid-plane M of the pocket 5 illustrated furthest to the right lies as a projection in the illustration of FIG. 2. The sectional plane illustrated touches a tapered surface at its curve of intersection with the mid-plane M.

The double bridge is shaped symmetrically with respect to the radially extending mid-plane M. The double bridge is constructed from two arcuate elastically designed subsections 8, 9 of the first cage side ring 3 which are arranged next to one another in a circumferential direction U of the cage 2 which corresponds to a circumferential direction U of the tapered roller bearing 1. The two arcuate subsections 8, 9 curve away from the inner region 10 of the pocket 5, said inner region being delimited by two adjacent webs 4 and the first cage side ring 3. This means that, in the region of the side face, facing the inner region 10, of the double bridge, two concave rounded depressions 23 arranged next to one another are formed between two adjacent webs 4. The two arcuate subsections 8, 9 are connected to one another in a connection region 11. The side face, pointing toward the inner region 10, of the double bridge has in the connection region 11 a planar surface portion 24 against which a tapered roller received in the pocket 5 bears in sliding contact when the cage is used in a tapered roller bearing. The effect of a force acting in the axial direction on the tapered roller 6 which comes to bear is that the surface portion 24 is also acted upon by this force and the connection region 11 moves back resiliently on account of the elastic flexion of the arcuate subsections 8, 9.

A wall thickness 12 of the two arcuate subsections 8, 9 first decreases from the connection region 11 in the direction toward the two webs 4 adjacent to the pocket 5 and delimiting the inner region 10 of the pocket 5, but then increases again. As a result, each arcuate elastically designed subsection 8, 9 in the first cage side ring 3 has a region of smallest wall thickness 12 which is arranged between the adjacent web 4 and the connection region 11. In FIG. 2, the configuration of the wall thickness 12 is indicated by the example of the pocket 5 illustrated furthest to the right, in a section through the cage 2 which is drawn in the tangential direction. The elasticity of the elastically deformable portion 7 is thereby further improved.

The elastically deformable portions 7 designed as double bridges are provided in the region of each of the pockets 5 arranged along the cage circumference. Thus, all the tapered rollers 6 distributed along the bearing circumference can be elastically prestressed resiliently.

Each of the webs 4 is provided in the region of its radially inner and of its radially outer boundary surfaces 13 in each case with a recess 14. The recess 14 runs in the form of a longitudinal groove 14 in the longitudinal direction of the web 4. The cross-section of each longitudinal groove 14 is in the shape of a segment of a circle, thus giving rise to a rounded groove bottom. By a groove being provided, material is saved in regions of the web in which material is not absolutely necessary for strength reasons. The resultant reduction in cross-section of the web 4 leads within the cage 2 cast in one piece to a more uniform distribution of the cross-sections of individual portions. As a result, the reliability of the manufacturing process is increased, the manufacturing operation is speeded up and the quality of the finished cage is improved. Furthermore, by means of the rounded groove bottom, an undesirable concentration of mechanical stresses in the region of the recess 14 is avoided.

The groove 14 running in the longitudinal direction of the web 4 forms two ribs 15 which likewise run in the longitudinal direction of the web 4 and are parallel to one another. The ribs 15 extend over the entire length of each web 4, that is to say from the first cage side ring 3 to the second cage side ring 17. As shown by the pocket 5 illustrated furthest to the left in FIG. 2, each of the ribs 15 is connected to an end portion 16 of an adjacent double bridge.

The second cage side ring 17 is provided along its circumference with a plurality of projections 18 which are connected in one piece to the second cage side ring 17 on its axially outer surface which faces away from the inner region 10 of the pockets 5. The projections 18 project from the second cage side ring 17 and first extend outward away from the inner region 10 of the pockets 5 in the axial direction A, then toward the bearing axis in the radial direction R and toward the second cage side ring 17 in the axial direction A. The projections 18 are consequently designed in hook form in such a way that they can be inserted into an assigned groove 20 provided on an inner ring rim 19 of a tapered roller bearing 1.

Each of the pockets 5 provided along the circumference of the cage 2 is assigned a projection 18 on the second cage side ring 17. As shown in FIG. 2, the projection 18 is designed symmetrically with respect to the radially extending mid-plane M of the pocket 5.

The cage 2 explained with reference to FIGS. 1 and 2 for a tapered roller bearing 1 is produced by injection molding from a thermoplastic which has sufficient mechanical load-bearing capacity and is resistant to the lubricants used for lubricating the tapered roller bearing. The cage, in spite of its special geometric configuration, can therefore be produced simply and cost-effectively.

FIG. 3 shows a tapered roller bearing 1 with a cage 2 according to the invention in the assembled state. The tapered roller bearing 1 has an inner ring 21 and an outer ring 22. Both the inner ring 21 and the outer ring 22 are provided in each case with a running surface in the form of a tapered surface. Between the running surfaces of inner ring 21 and outer ring 22 are arranged tapered rollers 6 which, when the tapered roller bearing 1 is in operation, roll on the running surfaces and thus enable axial and radial loads to be transmitted. Whereas the outer ring 22 is formed without a rim, the inner ring 21 has in the region of its large diameter an inner ring rim 19 with a guide groove 20.

To guide the tapered rollers 6 in the bearing 1, a cage 2 is provided which has a first cage side ring 3 and a second cage side ring 17. Furthermore, according to the exemplary embodiment of the cage according to the invention, the cage is configured as described in detail above with reference to FIGS. 1 and 2.

The projections 18 provided on the second cage side ring 17 surround the inner ring rim 19 when the tapered roller bearing 1 is in the assembled state. As a result of the hook shape of the radially extending projection 18, the latter engages, on that side face of the inner ring rim 19 which faces away from the tapered roller 6, into the assigned guide groove 20 provided on this side face.

The dimension of the tapered roller 6 along its axis is selected with respect to the inner dimensions of the inner region 10 of the pocket 5 of the cage 2 such that in the assembled state of the tapered roller bearing 1 the tapered roller 6 bears against the planar surface portion 24, as illustrated in FIG. 3. Furthermore, the longitudinal dimension of the tapered roller is selected such that the latter, after the assembly of the tapered roller bearing 1, is prestressed against the inner ring rim 19 as a result of elastic deformation of the elastically deformable portion 7, designed as a double bridge, of the first cage side ring 3. The elastic deformation of the double bridge involves, in particular, a variation in position of the connection region 11 essentially along the axis of the tapered roller 6 and an accompanying elastic flexion of the two arcuate elastically designed subsections 8, 9. So that prestressing of the tapered rollers 6 against the rim 19 becomes possible, the cage 2 is supported on the inner ring rim 19 in the axial direction by means of the projections 18.

Although the invention was described above by means of preferred exemplary embodiments, it will not be restricted to these, but instead can be modified in many different ways, without departing from the subject matter of the present invention.

In particular, the invention is not limited to the construction, explained above by means of the exemplary embodiment of the cage, of the side margin of the pockets as a double bridge formed by two elastically designed arcuate subsections of the first cage side ring. It is also conceivable to construct the elastically deformable portion of the cage side ring in the region of a pocket from three or more arcuate elastically designed subsections.

Furthermore, particularly in the case of rolling bearings of large diameter, it is also conceivable to manufacture the cage from metallic material, in particular from steel, in which case the cage side ring may again be designed in the form of a double or multiple bridge in the region of the pockets.

Moreover, the cage according to the invention is also not restricted to use in a tapered roller bearing, but could also be used in other rolling bearings, such as, for example, cylindrical roller bearings. The size ratios within the cage according to the invention may, of course, vary as a function of the geometry of the respective rolling bearing, in particular the geometry of the running surfaces and of the bearing ring rims, and as a function of the dimensions of the rolling bodies.

It is also conceivable not to arrange the multiple bridge structure of the first cage side ring in the region of each pocket, but instead to provide it only in the region of some of the pockets of the cage which are provided for receiving rolling bodies.

### LIST OF REFERENCE SYMBOLS

1 Rolling Bearing
2 Cage
3 First Cage Side Ring
4 Web
5 Pocket
6 Rolling Body
7 Elastically Deformable Portion
8 Arcuate Elastically Designed Subsection
9 Arcuate Elastically Designed Subsection
10 Inner Region of the Pocket
11 Connection Region
12 Wall Thickness
13 Radially Inner or Outer Boundary Surface
14 Recess
15 Rib
16 End Portion
17 Second Cage Side Ring
18 Projection
19 Bearing Ring Rim
20 Guide Groove
21 Bearing Ring (Inner Ring)
22 Bearing Ring (Outer Ring)
23 Concave Rounded Depression
A Axial Direction of the Rolling Bearing or Cage
R Radial Direction of the Rolling Bearing or Cage
U Circumferential Direction of the Rolling Bearing or Cage

1-15. (canceled)

16. A cage for a rolling bearing, comprising:
a first cage side ring; and
a plurality of webs which project from the first cage side ring and are spaced apart from one another in such a way that pockets for receiving rolling bodies are formed,
wherein the first cage side ring has an elastically deformable portion in a region of a pocket, which deformable portion is designed as a multiple bridge arranged between two of the webs which are adjacent to each other.

17. The cage as claimed in claim 16, wherein the multiple bridge is symmetrical with respect to a radially extending mid-plane of the pocket.

18. The cage as claimed in claim 16, wherein the multiple bridge is formed by at least two arcuate elastic subsections of the first cage side ring.

19. The cage as claimed in claim 18, wherein the subsections each have a curvature that points away from an inner region of the pocket, and the inner region is delimited by two of the webs which are adjacent to each other and the first cage side ring.

20. The cage as claimed in claim 18, wherein the multiple bridge is a double bridge formed by two arcuate elastic subsections connected to one another in a connection region, and the two arcuate elastic subsections have a wall thickness that first decreases from the connection region toward the webs on both sides, and then increases again.

21. The cage as claimed in claim 16, wherein one of the webs is provided in a region of a radially inner and/or a radially outer boundary surface with a recess running in a longitudinal direction of the one of the webs.

22. The cage as claimed in claim 21, wherein the recess is a longitudinal groove with a groove bottom that is rounded.

23. The cage as claimed in claim 21, wherein the recess is a longitudinal groove with a cross-section forming a segment of a circle.

24. The cage as claimed in claim 22, wherein the recess forms two ribs running in the longitudinal direction of the one of the webs that are shaped symmetrically with respect to the recess, each of the ribs being connected to an end portion of the multiple bridge adjacent to the ribs.

25. The cage as claimed in claim 16, further comprising a second cage side ring which is spaced apart from the first cage side ring and which is connected to the first cage side ring by the webs.

26. The cage as claimed in claim 25, wherein the first cage side ring has a smaller diameter than the second cage side ring.

27. The cage as claimed in claim 25, wherein the second cage side ring has a plurality of radially extending projections which are insertable into an assigned groove provided on a bearing ring rim of the rolling bearing.

28. The cage as claimed in claim 27, wherein each of the pockets is assigned to one of the projections, and the one of the projections is symmetrical with respect to a radially extending mid-plane of the pocket.

29. The cage as claimed in claim 16, wherein the cage is made of a one piece injection molded thermoplastic.

30. A rolling bearing, comprising:
at least one cage having a first cage side ring and a plurality of webs which project from the first cage side ring and are spaced apart from one another in such a way that pockets for receiving rolling bodies are formed, wherein the first cage side ring has an elastically deformable portion in a region of a pocket, which deformable portion is designed as a multiple bridge arranged between two of the webs which are adjacent to each other.

31. The rolling bearing as claimed in claim 30, further comprising bearing rings, wherein one of the bearing rings has a bearing ring rim and a guide groove running in a circumferential direction of the bearing provided on the bearing ring rim, and wherein the cage gas a second side ring which has radially extending projections surrounding the bearing ring rim so that the projections engage into the guide groove.
